(19) United States
(12) Patent Application Publication
(10) Pub. No.: US 2003/0129367 A1
(43) Pub. Date: Jul. 10, 2003

(54) Magnetic recording medium

(75) Inventor: Akira Kasuga, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/196,175

(22) Filed: Jul. 17, 2002

(30) Foreign Application Priority Data
Jul. 23, 2001 (JP) P.2001-221651
Jul. 23, 2001 (JP) P.2001-221652

(51) Int. Cl. B32B 9/00

(52) U.S. Cl. 428/195; 428/692; 428/694 TR; 428/694 B

(57) ABSTRACT

A magnetic recording medium comprising a support having provided on one side thereof a magnetic layer containing a ferromagnetic powder and a binder, wherein the magnetic layer surface has protrusions having a height of from 20 to 50 nm in the number of from 20 to 150 per 900 μm² of the surface, and a magnetic recording medium comprising a support having provided thereon a magnetic layer containing a ferromagnetic powder and a binder, wherein the magnetic layer surface has the following protrusion distributions of the protrusion heights: protrusion number a of protrusion height of region A (20 nm or more and less than 30 nm) accounts for from 52.5 to 92.5% (A), protrusion number b of protrusion height of region B (30 nm or more and less than 40 nm) accounts for from 9 to 29% (B), and protrusion number c of protrusion height of region C (40 nm or more) accounts for from 0 to 18.5% (C), where 100×a/(a+b+c)=A, 100×b/(a+b+c)=B, and 100×c/(a+b+c)=C.

### FIELD OF THE INVENTION

The present invention relates to a magnetic recording medium, in particular, a magnetic recording medium capable of being used as a magnetic recording medium for computer data recording suitable for a helical scan system magnetic recording medium having extremely narrow track breadth (i.e., narrow track width) for data recording.

### BACKGROUND OF THE INVENTION

With the spread of the office computer, such as minicomputers, personal computers and work stations, magnetic tapes for recording computer data as external storage media, so-called backup tapes, have been used.

The backup tape is earnestly desired to have large recording capacity and high running durability by the improvement of the information processing performance of the computer and the increase of throughput, and required, in convenience of use, to be less in head wear (i.e., head abrasion) and long-lived as the desire regarding the head for effectively performing recording and reproduction of the recording medium.

The backup tape is also desired to hardly generate errors at recording and reproducing times of data and have high reliability under wide environmental conditions of use (in particular, under highly fluctuating temperature and humidity conditions) along with the widening of the use environment of the computer.

The magnetic tape in general comprises a nonmagnetic flexible support, such as synthetic resins, having provided thereon a magnetic layer. For achieving higher recording density, a magnetic tape of the constitution comprising a nonmagnetic support having provided thereon a nonmagnetic layer, and further a thin magnetic layer is provided on the nonmagnetic layer is proposed.

For example, a magnetic tape of two-layer structure comprising a nonmagnetic support having provided thereon in order of a nonmagnetic layer and a magnetic layer having a thickness of 1.0 μm or less is disclosed in JP-A-5-182178 (the term “JP-A” as used herein means an “unexamined published Japanese patent application”). The same patent discloses that a magnetic tape of two-layer structure having such a thin magnetic layer as above can also be used for computer data recording, and as the layer constitution of the magnetic tape, it is preferred that the nonmagnetic support has a thickness of from 4 to 80 μm, the lower nonmagnetic layer has a thickness of from 1.0 to 5.0 μm, and the upper magnetic layer has a thickness of from 0.05 to 0.6 μm (preferably from 0.05 to 0.3 μm).

Specifically, a magnetic tape comprising a polyethylene terephthalate support having a thickness of 7 μm having provided thereon in order of a nonmagnetic layer having a thickness of 2 μm and a magnetic layer having a thickness of 0.2 μm is disclosed in the Example in the same patent. The patent also discloses that an aromatic polyamide can be used as the material of a support.

Although the magnetic tape of two-layer structure having a thin magnetic layer disclosed in the same patent is relatively thin in the entire thickness and advantageous for high density recording, sufficient recording capacity cannot be achieved for use as the magnetic tape for computer data recording.

On the other hand, the thicknesses of a magnetic layer and a nonmagnetic layer directly affect running durability and the touch of the magnetic recording medium with a magnetic head (the state of contact with a magnetic head). As a result, the repercussions are liable to come over electromagnetic characteristics, e.g., reproduction output. Accordingly, the development of a magnetic tape suitable for computer data recording which is restricted in the entire thickness and moreover capable of satisfying the above-described performances is required. In particular, for ensuring data having high reliability for computer data, a magnetic recording medium low in error rate and high in margin becomes necessary more and more. Further, speaking with respect to the touch of the magnetic recording medium with a magnetic head, when the thickness of the magnetic recording medium itself is thin, the touch with a magnetic head (head contact) is good, which often results in the increase of head wear. Further, there arises a problem of causing the damage of edge at the end face of the tape (folding of the end face, one side elongation of the edge due to heavy rubbing, and peeling of the magnetic layer).

Furthermore, a helical scan system using a rotary magnetic head has been adopted as a magnetic recording and reproducing system, and for achieving higher recording density, the development of a magnetic recording system capable of recording and reproducing data on a data-recording track having an extremely narrow track breadth (i.e., narrow track width) than before has been advanced. However, when the thickness of a magnetic tape as a whole becomes markedly thin, a problem that off-track (a phenomenon that a magnetic tape deviates from a normal track so that faithful recording and reproduction become impossible and data cannot be read) is liable to occur arises.

### SUMMARY OF THE INVENTION

Accordingly, an object of the present invention is to provide a magnetic recording medium which is advantageously used as a magnetic tape for computer data recording capable of achieving higher recording capacity and exhibiting high running durability and also stable performance against fluctuations, e.g., temperature.

Another object is to provide a magnetic recording medium which is advantageously used as a magnetic tape for computer data recording capable of achieving higher recording capacity, low in error rate and high in margin for ensuring highly reliable data as computer data, excellent in high running durability, low in reduction of performance in electromagnetic characteristics after storage, and exhibiting stable performance.

A further object is to provide a magnetic recording medium which is advantageously used as a highly reliable magnetic tape for computer data recording answering to a helical scan system using a rotary magnetic head as a magnetic recording and reproducing system, having high recording capacity, excellent in running durability and electromagnetic characteristics, having a small friction coefficient, less in running resistance and the damage of edge, and advantageous to head wear.

A still further object is to provide a magnetic recording medium which is advantageously used as a magnetic tape for computer data recording capable of high density recording and suitable for a magnetic recording and reproducing system.

The present invention has been achieved by a magnetic recording medium comprising a support having provided on one side thereof a magnetic layer containing a ferromagnetic powder and a binder, wherein the magnetic layer surface has protrusions having a height of from 20 to 50 nm in the number of from 20 to 150 per 900 μm² of the surface.

The following items (1) to (6) are also the preferred embodiments of the present invention.

(1) The magnetic recording medium as described above, wherein the support is an aromatic polyamide support or a polyethylene naphthalate support having a thickness of from 1.0 to 6.0 μm, preferably from 1.5 to 5.8 μm.

(2) The magnetic recording medium as described above, wherein the entire thickness of the magnetic recording medium is 7.0 μm or less.

(3) The magnetic recording medium as described above, wherein the magnetic layer of the magnetic recording medium has a thickness of from 0.01 to 0.25 μm.

(4) The magnetic recording medium as described above, wherein the magnetic recording medium is a magnetic tape for a magnetic recording and reproducing system having a track breadth (track pitch) of 7.0 μm or less, preferably from 3 to 7 μm.

(5) The magnetic recording medium as described above, wherein the magnetic recording medium is a magnetic tape for computer data recording.

(6) The magnetic recording medium as described above, wherein the magnetic recording medium is used for recording and reproduction by a helical scan system.

Further, the above objects of the present invention have been achieved by a magnetic recording medium comprising a support having provided thereon a magnetic layer containing a ferromagnetic powder and a binder, wherein the magnetic layer surface has the following protrusion distributions of the protrusion heights:

protrusion number a of protrusion height in region A (20 nm or more and less than 30 nm) accounts for from 52.5 to 92.5% (A),

protrusion number b of protrusion height in region B (30 nm or more and less than 40 nm) accounts for from 9 to 29% (B), and

protrusion number c of protrusion height in region C (40 nm or more) accounts for from 0 to 18.5% (C),

where 100×a/(a+b+c)=A, 100×b/(a+b+c)=B, and 100×c/(a+b+c)=C.

The following items (1) to (6) are also the preferred embodiments of the present invention.

(1) The magnetic recording medium as described above, wherein a lower layer (a nonmagnetic layer) containing a nonmagnetic powder and a binder as the main components is provided between the support and the magnetic layer.

(2) The magnetic recording medium as described above, wherein the support is an aromatic polyamide support or a polyethylene naphthalate support having a thickness of from 1.0 to 6.0 μm, preferably from 1.5 to 5.8 μm.

(3) The magnetic recording medium as described above, wherein the entire thickness of the magnetic recording medium is 7.0 μm or less.

(4) The magnetic recording medium as described above, wherein the magnetic layer has a thickness of from 0.01 to 0.25 μm.

(5) The magnetic recording medium as described above, wherein the magnetic recording medium is a magnetic tape for a magnetic recording and reproducing system having a track breadth (track pitch) of 7.0 μm or less, preferably from 3 to 7 μm.

(6) The magnetic recording medium as described above, wherein the magnetic recording medium is a magnetic tape for computer data recording.

(7) The magnetic recording medium as described above, wherein the magnetic recording medium is used for recording and reproduction by a helical scan system.

### DETAILED DESCRIPTION OF THE INVENTION

The present invention is described in further detail below.

The present invention has made it possible to provide an optimal magnetic recording medium by restricting the number of protrusions having a height of from 20 to 50 nm on the surface of a magnetic layer to 20 to 150, preferably from 30 to 145, per 900 μm² of the surface. By maintaining the above range of the protrusion heights and the protrusion number on the surface of the magnetic layer of a magnetic recording tape, the contact area of the magnetic layer with a magnetic head can be made efficient and optimal, thereby a magnetic recording medium not accompanied by the impairment of electromagnetic characteristics and running durability can be provided.

The number of the protrusions on the surface of a magnetic layer means the number of the protrusions present in the area of 30 μm×30 μm of a magnetic tape, and the measuring method is described in the item of the evaluation of a magnetic tape in the Example later.

Another invention has made it possible to provide an optimal magnetic recording medium by providing the protrusion distribution of the specific protrusion height on the surface of a magnetic layer.

The protrusion distributions of the protrusion heights are those specifying the proportion (the proportion of occupancy) of the number per unit area of each protrusion showing the protrusion height of region A (20 nm or more and less than 30 nm), the protrusion height of region B (30 nm or more and less than 40 nm), and the protrusion height of region C (40 nm or more), and taking the number of protrusions in region A as a, the number of protrusions in region B as b, and the number of protrusions in region C as c, the proportion of the number of protrusions in region A, A=100×a/(a+b+c) is from 52.5 to 92.5%, preferably from 55.0 to 91.5%, and more preferably from 56.0 to 91.0%, the proportion of the number of protrusions in region B, B=100×b/(a+b+c) is from 9 to 29%, preferably from 10.0 to 25.0%, and the proportion of the number of protrusions in region C, C=100×c/(a+b+c) is from 0 to 18.5%, preferably from 0.00 to 17.0%.

The above protrusion distribution of protrusion height can be obtained by AFM (an atomic force microscope). The protrusion distribution of the protrusion height in the present invention was obtained with AFM NANOSCOPE III (manufactured by DIGITAL INSTRUMENT).

The measurement is performed by scanning the area of 30 μm×30 μm of the measuring range on the magnetic layer by contact mode at scanning velocity of 0.25 second/line or more.

The protrusion height in each region means the distance from the following reference plane to the top of the protrusion. The reference plane is the plane where the volumes of the convexities and the concavities in the area of measurement of the magnetic layer become equal. The number obtained by subtracting the number intersecting the protrusions when the magnetic layer surface is sliced at the height of 29.4 nm from the reference plane from the number intersecting the protrusions when sliced at the height of 19.5 nm from the reference plane is taken as protrusion number a. Similarly, the number obtained by subtracting the number intersecting the protrusions when the magnetic layer surface is sliced at the height of 39.4 nm from the reference plane from the number intersecting the protrusions when sliced at the height of 29.5 nm from the reference plane is taken as protrusion number b. The number intersecting the protrusions when the magnetic layer surface is sliced at the height of 39.5 nm or higher from the reference plane is taken as protrusion number c. The proportions A, B and C are obtained from these protrusion numbers a, b and c, respectively.

Further, the protrusions in the area other than the above, i.e., the protrusions lower than 20 nm in height, do not affect electromagnetic characteristics from the viewpoint of the surface property of the magnetic layer of a magnetic recording medium.

By maintaining the protrusion distribution of the protrusion height on the magnetic layer surface in the above range, the contact area of the magnetic layer with a magnetic head can be made efficient and optimal, an error rate can be made low, thereby a magnetic recording medium not accompanied by the impairment of electromagnetic characteristics and running durability can be provided.

Further, the present invention can provide a magnetic tape for computer data recording showing a small friction coefficient and less running resistance, less in the damage of edge, advantageous to head wear, and highly reliable even with the thickness of the magnetic recording medium as thin as 7.0 μm or less.

In one embodiment of the present invention, the magnetic recording medium comprises an aromatic polyamide support or a polyethylene naphthalate support having provided on one side thereof a substantially nonmagnetic lower layer containing a nonmagnetic powder and a binder and a magnetic layer containing a ferromagnetic powder and a binder in this order. A back coat layer may be provided on the other side of the support arbitrarily, or a servo signal-controlling magnetic layer may be provided. It is preferred that the entire thickness of the magnetic recording medium is 7.0 μm or less, and the thickness of the magnetic layer is from 0.01 to 0.25 μm. The both surfaces of the aromatic polyamide support or the polyethylene naphthalate support may be arbitrarily subjected to corona discharge treatment, depending upon the purpose.

The magnetic tape for computer data recording, i.e., the backup tape, tends to become thin more and more in recent years with an increase in capacity. The requisite characteristic to the backup tape with thinning is high density recording, i.e., to achieve high recording capacity and to ensure stable running durability. A friction coefficient can be made small and an error rate can be reduced by maintaining the above range of the protrusion heights and the protrusion numbers on the surface of the magnetic layer of a magnetic recording tape, or by maintaining the protrusion distribution of the protrusion height on the magnetic layer surface in the above range, and head wear can be reduced by lessening the contact area of the magnetic layer with a magnetic head, thereby the magnetic tape for computer data recording in which electromagnetic characteristics and running durability are well-balanced can be obtained. That is, the edge of the tape is hardly damaged during repeating running of the tape and the magnetic tape for computer data recording highly reliable in running durability has been realized.

By the magnetic recording medium in the present invention, a magnetic recording method of recording on a tape-like magnetic recording medium with a data track breadth (i.e., a data track width) of 7.0 μm or less using a rotary magnetic head by a helical scan system has been realized.

The present inventors have found that a magnetic recording medium capable of being advantageously used as a highly reliable magnetic tape for computer data recording showing a small friction coefficient, less in error rate, less in head wear, stable in running durability, showing less reduction of performance in electromagnetic characteristics after storage can be obtained, although the entire thickness of a magnetic recording medium is made as thin as 7.0 μm or less by thinning a magnetic layer thickness than before, which is good in head touch.

There are various methods of modifying the protrusion distribution of the protrusion height on the surface of a magnetic layer, i.e., modifying the surface protrusion number and the surface protrusion height, e.g., a method of changing forming conditions, such as the temperature, pressure and rate of calendering, a method of changing the degree of kneading in kneading treatment of a magnetic powder and a binder at treating step before dispersion by using a great amount of organic solvents, such as from weak kneading to strong kneading, and calendering conditions can be arbitrarily selected by changing the residual amount of the solvent in a magnetic layer at coating. Further, a method of changing a magnetic layer surface or a method of adding a nonmagnetic powder in prescription are exemplified. In the present invention, the addition of a small amount of carbon black to a magnetic layer can be exemplified as the most sure means of capable of changing a magnetic layer surface.

The preferred modes of using carbon blacks in the magnetic layer for realizing the surface protrusion numbers and the surface protrusion heights according to the present invention are described below.

The average particle size of carbon blacks is preferably from 10 to 300 nm, more preferably from 20 to 150 nm.

The addition amount of carbon blacks to ferromagnetic powders is generally from 0.01 to 30 mass % (i.e., weight %), preferably from 0.05 to 20 mass %.

Furnace blacks for rubber, thermal blacks for rubber, carbon blacks for coloring and acetylene blacks can be used in the magnetic layer. Carbon blacks for use in the magnetic layer in the present invention preferably have a specific surface area (S_{BET}) of from 5 to 500 m²/g, preferably from 8 to 250 m²/g, a DBP oil absorption amount of from 10 to 400 ml/100 g, preferably from 30 to 380 ml/100 g, pH of from 2 to 10, a water content of from 0.1 to 10%, and a tap density of from 0.1 to 1.0 kg/liter (0.1 to 1.0 g/ml).

The specific examples of carbon blacks for use in the magnetic layer of the present invention include BLACKPEARLS 2000, 1300, 1000, 900, 800 and 700, and VULCAN XC-72 (manufactured by Cabot Co., Ltd.), #80, #60, #55, #50 and #35 (manufactured by Asahi Carbon Co., Ltd.), #2400B, #2300, #5, #900, #950, #970, #1000, #30, #40 and #10B (manufactured by Mitsubishi Kasei Corp.), and CONDUCTEX SC, RAVEN 150, 50, 40 and 15 (manufactured by Columbia Carbon Co., Ltd.).

Carbon blacks for use in the present invention may be surface-treated with a dispersant, may be grafted with a resin, or a part of the surfaces of carbon blacks may be graphitized before use. Carbon blacks may be previously dispersed in a binder before addition to a magnetic coating solution. These carbon blacks may be used alone or in combination. Carbon blacks can serve various functions such as preventing static charges, reducing a friction coefficient, imparting a light-shielding property and improving film strength, and such functions vary depending upon the kind of carbon blacks to be used. Regarding carbon blacks for use in the magnetic layer in the present invention, for example, the description in Handbook of Carbon Blacks (edited by Carbon Black Association) can be referred to.

As nonmagnetic flexible supports, films such as polyesters, e.g., polyethylene terephthalate and polyethylene naphthalate, polyolefins, cellulose triacetate, polycarbonate, polyamide, polyimide, polyamideimide and polysulfone can be used in the present invention. Polyethylene naphthalate and aromatic polyamide are preferably used.

The F-5 value of the nonmagnetic support in the running direction of the tape is preferably from 5 to 50 kg/mm² (from 49 to 490 MPa), and the F-5 value in the transverse direction is preferably from 3 to 30 kg/mm² (from 29.4 to 294 MPa). The F-5 value in the machine direction is in general higher than the F-5 value in the transverse direction, however, when the strength in the transverse direction of the tape is particularly required to be heightened, this rule does not apply to the case.

The thermal shrinkage factor of the support in the running direction and the transverse direction of the tape at 100° C. for 30 minutes is preferably 3% or less, more preferably 1.5% or less, and the thermal shrinkage factor at 80° C. for 30 minutes is preferably 1% or less, more preferably 0.5% or less. The support has breaking strength in both directions of from 5 to 100 kg/mm² (from 49 to 980 MPa), and the modulus of elasticity of preferably from 100 to 2,000 kg/mm² (0.98 to 19.6 GPa) The thickness of the support is preferably from 1.0 to 6.0 μm, more preferably from 1.5 to 5.8 μm.

The support maybe subjected to corona discharge treatment and static charge eliminating treatment before use according to the use purpose of the magnetic tape.

Specifically, both surfaces of a long-size aramid support and a polyethylene naphthalate support are subjected to corona discharge treatment (using a pillar corona treater, manufactured by Toyo Pillar Co., Ltd.) by attaching an electrode on the coated surface of the support, and a dielectric body (a ground plate) on the opposite surface, and applying plate current (50 mA) to the electrode by a high-frequency oscillator.

Corona discharge treatment can be performed on both surfaces of a support as above. Subsequently, the support after corona discharge treatment is subjected to static charge eliminating treatment with an ion air generator (manufactured by Shinko Co., Ltd.).

The magnetic layer of the magnetic recording medium in the present invention comprises a ferromagnetic powder dispersed in a binder. The ferromagnetic powders which can be used are a ferromagnetic iron oxide, a cobalt-containing ferromagnetic iron oxide, a barium ferrite powder and a ferromagnetic metal powder.

The examples of the ferromagnetic metal powders which can be used in the present invention include alone substances or alloy powders of Fe, ni, Fe—Co, Fe—Ni, Co—Ni and Co—Ni—Fe, and the alloy powders can contain the following elements in the range of 20 mass % or less based on the total amount of the metal components, e.g., aluminum, silicon, sulfur, scandium, titanium, vanadium, chromium, manganese, copper, zinc, yttrium, molybdenum, rhodium, palladium, gold, tin, antimony, boron, barium, tantalum, tungsten, rhenium, silver, lead, phosphorus, lanthanum, cerium, praseodymium, neodymium, tellurium, or bismuth.

As is disclosed in JP-A-8-255334, the ferromagnetic metal powders containing from 10 to 40 atomic % of Co, from 2 to 20 atomic % of Al, and from 1 to 15 atomic % of Y, each based on Fe, are preferably used in the present invention from the viewpoint of capable of lessening sintering and obtaining excellent dispersing property. Further, the ferromagnetic metal powders may contain a small amount of water, a hydroxide or an oxide.

It is preferred for the ferromagnetic powders for use in the magnetic layer of the magnetic recording medium in the present invention to contain Fe as the main component, have an average long axis length of from 0.05 to 0.19 μm, and a crystallite size of from 100 to 230 angstroms, for the purpose of highly packing the ferromagnetic powders with reducing noise. Further, it is preferred for the ferromagnetic powders for use in the magnetic layer of the magnetic recording medium in the present invention to have a coercive force (Hc) of generally from 79 to 316 kA/m and saturation magnetization (σₛ) of generally from 90 to 170 A·m²/kg in the light of reducing demagnetization loss by recording and preventing the reduction of magnetization due to thermal fluctuation. Further, it is preferred for the ferromagnetic powders to have a specific surface area of from 35 to 60 m²/g and pH of 7 or more for the purpose of obtaining appropriate viscosity of the dispersion solution and the affinity with a binder.

When the ferromagnetic powders are hexagonal ferrite ferromagnetic powders, the tabular diameter is preferably 40 nm or less, more preferably from 10 to 35 nm.

The range of the coercive force (Hc) of the hexagonal ferrite ferromagnetic powders is preferably the same as that of acicular alloy powders. The hexagonal ferrite ferromagnetic powders have σₛ of from 45 to 75 A·m²/kg, preferably from 50 to 70 A·m²/kg, a tabular ratio (tabular diameter/tabular thickness) of from 2 to 15, preferably from 3 to 8, and an average particle volume of from 2,000 to 12,000 nm³, preferably 3 from 3,000 to 10,000 nm³. These ferromagnetic powders are well-known and the ferromagnetic powders for use in the present invention can also be prepared by well-known methods.

The shape of the ferromagnetic powders is not particularly limited, and any shape such as an acicular, granular, die-like, ellipsoidal (also called spindle-like) and tabular shapes can be used. Acicular and spindle-like ferromagnetic powders are particularly preferably used.

In the present invention, a magnetic layer-forming coating solution is prepared by kneading and dispersing a binder, a hardening agent and a ferromagnetic powder with a solvent, e.g., methyl ethyl ketone, dioxane, cyclohexanone or ethyl acetate which is generally used for preparing a magnetic coating solution. Kneading and dispersing can be performed by ordinary methods.

As the abrasive which can be used in the magnetic layer according to the present invention, well-known materials essentially having a Mohs' hardness of 6 or more are used alone or in combination, e.g., alpha-alumina having an alpha-conversion rate of 90% or more, beta-alumina, fine particle diamond, silicon carbide, chromiumoxide, ceriumoxide, alpha-iron oxide, corundum, silicon nitride, silicon carbide, titanium carbide, titanium oxide, silicon dioxide, and boron nitride. Composites composed of these abrasives (abrasives treated with other abrasives) may also be used. Compounds or elements other than the main component are often contained in these abrasives, but the intended effect can be obtained so far as the content of the main component is 90 mass % (i.e., weight %) or more. These abrasives preferably have a particle size of from 0.01 to 1 μm and, in particular, for improving electromagnetic characteristics, abrasives having narrow particle size distribution are preferred. Further, for improving durability, a plurality of abrasives each having a different particle size may be combined as required, or a single abrasive having a broad particle size distribution may be employed so as to achieve the same effect as such a combination. Preferably, abrasives for use in the present invention have a tap density of from 0.3 to 1.5 g/ml, a water content of from 0.1 to 5 mass %, a pH value of from 2 to 11, and a specific surface area (S_{BET}) of from 1 to 40 m²/g. The shape of the abrasives to be used in the present invention may be any of acicular, spherical and die-like shapes. Abrasives having a shape partly with edges are preferred, because a high abrasive property can be obtained. The specific examples of the abrasives for use in the present invention include AKP-10, AKP-15, AKP-20, AKP-30, AKP-50, HIT-20, HIT-30, HIT-50, HIT-60A, HIT-50G, HIT-70, HIT-80, HIT-82 and HIT-100 (manufactured by Sumitomo Chemical Co., Ltd.), ERC-DBM, HP-DBM and HPS-DBM (manufactured by Reynolds International Inc.), WA10000 (manufactured by Fujimi Kenma K. K.), UB20 (manufactured by Uemura Kogyo K. K.), G-5, Kromex U2 and Kromex U1 (manufactured by Nippon Chemical Industrial Co., Ltd.), TF100 and TF140 (manufactured by Toda Kogyo Co., Ltd.), beta-Random Ultrafine (manufactured by Ibiden Co., Ltd.), and B-3 (manufactured by Showa Mining Co., Ltd.). These abrasives may also be added to the lower layer, if necessary. By adding abrasives into the lower layer, it is possible to control the surface shape or prevent abrasives from protruding. The particle sizes and amounts of abrasives to be added to the magnetic layer and the lower layer should be selected independently at optimal values.

As the examples of the binders for use in the present invention, cellulose derivatives (e.g., nitrocellulose, cellulose acetate), vinyl chloride/vinyl acetate copolymer resins (e.g., vinyl chloride/vinyl acetate copolymers, vinyl chloride/vinyl acetate/vinyl alcohol copolymers, vinyl chloride/vinyl acetate/maleic anhydride copolymers), vinylidene chloride resins (e.g., vinylidene chloride/vinyl chloride copolymers, vinylidene chloride/acrylonitrile copolymers), polyester resins (e.g., alkyd resins, linear polyesters), acrylic resins (e.g., acrylic acid/acrylonitrile copolymers, methyl acrylate/acrylonitrile copolymers), polyvinyl acetal resins, polyvinyl butyral resins, phenoxy resins, epoxy resins, butadiene/acrylonitrile copolymers, polyurethane resins and urethane epoxy resins can be exemplified, and these resins can be used alone or in combination.

When the binder of the present invention is used, the above resins can be used in combination with a polyisocyanate compound to harden the magnetic layer. As the examples of such polyisocyanate compounds, the reaction products of 3 mols of diisocyanate, e.g., tolylene diisocyanate, xylylene diisocyanate, and hexamethylene diisocyanate, and 1 mol of trimethylolpropane, Biuret adducts of 3 mols of hexamethylene diisocyanate, isocyanurate compounds of 5 mols of tolylene diisocyanate, isocyanurate addition compounds of 3 mols of tolylene diisocyanate and 2 mols of hexamethylene diisocyanate, and diphenylmethane diisocyanate polymers can be exemplified. The amount of the binders for use in the present invention is not especially restricted, and they can be used in general from 10 to 100 mass parts (i.e., weight parts), preferably from 15 to 50 mass parts, per 100 mass parts of the ferromagnetic powder.

As the polyurethane resins, those having well-known structures, e.g., polyester polyurethane, polyether polyurethane, polyether polyester polyurethane, polycarbonate polyurethane, polyester polycarbonate polyurethane, and polycaprolactone polyurethane can be used. For the purpose of further improving the dispersibility and the durability, it is referred that at least one polar group selected from the following groups is introduced by copolymerization or addition reaction, with respect to all of the above binders,

e.g., —COOM, —SO₃M, —OSO₃M, —P═O(OM)₂, —O—P═O(OM)₂ (wherein M represents a hydrogen atom or an alkali metal salt group), —OH, —NR₂, —N⁺R₃ (R represents a hydrocarbon group), an epoxy group, —SH, or —CN. The content of the polar group is from 10⁻¹ to 10⁻⁸ mol/g, preferably from 10⁻² to 10⁻⁶ mol/g.

The organic solvents which are used in the present invention are selected from the following solvents and they are used in an optional proportion. The examples of suitable organic solvents include ketones, e.g., acetone, methyl ethyl ketone, methyl isobutyl ketone, diisobutyl ketone, cyclohexanone, isophorone and tetrahydrofuran; alcohols, e.g., methanol, ethanol, propanol, butanol, isobutyl alcohol, isopropyl alcohol and methylcyclohexanol; esters, e.g., methyl acetate, butyl acetate, isobutyl acetate, isopropyl acetate, ethyl lactate and glycol acetate; glycol ethers, e.g., glycol dimethyl ether, glycol monoethyl ether and dioxane; aromatic hydrocarbons, e.g., benzene, toluene, xylene, cresol and chlorobenzene; chlorinated hydrocarbons, e.g., methylene chloride, ethylene chloride, carbon tetrachloride, chlorofrom, ethylenechlorohydrin and dichlorobenzene; N,N-dimethylformamide and hexane. The organic solvents need not be 100% pure and may contain impurities such as isomers, non-reacted materials, byproducts, decomposed products, oxides and water, in addition to the main component. However, the content of such impurities is preferably 30% or less, more preferably 10% or less. The kinds of the organic solvents to be used in the magnetic layer and the nonmagnetic layer are preferably the same. The contents may be different from each other. For instance, a solvent having a high surface tension (e.g., cyclohexanone or dioxane) is used in the nonmagnetic layer so as to improve the coating stability. Specifically, it is essential that the arithmetic mean value of the solvent composition of the upper layer be higher than that of the lower layer. For the improvement of the dispersibility, the polarity is preferably high in some degree. It is preferred that a solvent having dielectric constant of 15 or higher is contained in an amount of 50% or more of the solvent composition. The solubility parameter is preferably from 8 to 11.

The layer thickness of the magnetic layer of the magnetic recording medium in the present invention is preferably from 0.01 to 0.25 μm. When the thickness of the magnetic layer is less than 0.01 μm, the magnetic layer comes to be substantially not a magnetic layer. When the magnetic layer thickness exceeds 0.25 μm, a so-called self demagnetization loss is great and at the same time the surface is roughened. The magnetic layer may comprise a single layer or a plurality of layers for achieving the objects of the present invention. When the magnetic layer is composed of a plurality of layers, the technique disclosed, e.g., in JP-A-6-139555 can be applied to.

The lower layer preferably comprises a nonmagnetic inorganic powder and a binder as the main components. The nonmagnetic inorganic powder for use in the lower layer can be selected from inorganic compounds, e.g., metallic oxide, metallic carbonate, metallic sulfate, metallic nitride, metallic carbide, metallic sulfide, etc. The examples of inorganic compounds are selected from the following compounds and they can be used alone or in combination, e.g., alpha-alumina having an alpha-conversion rate of 90% or more, beta-alumina, gamma-alumina, theta-alumina, silicon carbide, chromium oxide, cerium oxide, alpha-iron oxide, hematite, goethite, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, and molybdenum disulfide. Of these compounds, titanium dioxide, zinc oxide, iron oxide and barium sulfate are particularly preferred because they have small particle size distribution and various means for imparting functions, and titanium dioxide and alpha-iron oxide are more preferred. These nonmagnetic inorganic powders preferably have an average particle size of from 0.005 to 2 μm. If necessary, a plurality of nonmagnetic inorganic powders each having a different particle size may be combined, or a single nonmagnetic inorganic powder may have broad particle size distribution so as to attain the same effect as such a combination. These nonmagnetic inorganic powders particularly preferably have an average particle size of from 0.01 to 0.2 μm. In particular, when the nonmagnetic inorganic powder is a granular metallic oxide, the average particle size is preferably 0.08 μm or less, and when the nonmagnetic inorganic powder is an acicular metallic oxide, the average long axis length is preferably 0.3 μm or less, more preferably 0.2 μm or less. The nonmagnetic inorganic powders for use in the present invention have a tap density of generally from 0.05 to 2 g/ml, preferably from 0.2 to 1.5 g/ml, a water content of generally from 0.1 to 5 mass %, preferably from 0.2 to 3 mass %, and more preferably from 0.3 to 1.5 mass %, a pH value of generally from 2 to 11, and particularly preferably between 5.5 and 10, and a specific surface area (S_{BET}) of generally from 1 to 100 m²/g, preferably from 5 to 80 m²/g, and more preferably from 10 to 70 m²/g.

The nonmagnetic inorganic powders for use in the present invention have a crystallite size of preferably from 0.004 to 1 μm, and more preferably from 0.04 to 0.1 μm, an oil absorption amount amount using DBP (dibutyl phthalate) of from 5 to 100 ml/100 g, preferably from 10 to 80 ml/100 g, and more preferably from 20 to 60 ml/100 g, and a specific gravity of generally from 1 to 12, preferably from 3 to 6. The shape of the nonmagnetic inorganic powders may be any of an acicular, spherical, polyhedral or tabular shape. The nonmagnetic inorganic powders preferably have a Mohs' hardness of from 4 to 10. The SA (stearic acid) adsorption amount of the nonmagnetic inorganic powders is from 1 to 20 μmol/m², preferably from 2 to 15 μmol/m², and more preferably from 3 to 8 μmol/m². The pH of the nonmagnetic inorganic powders is preferably between 3 and 6. These nonmagnetic inorganic powders are preferably surface-treated with A1₂O₃, SiO₂, TiO₂, ZrO₂, SnO₂, Sb₂O₃, ZnO or Y₂O₃. Al₂O₃, SiO₂, TiO₂ and ZrO₂ are particularly preferred in the point of dispersing property, and Al₂O₃, SiO₂ and ZrO₂ are more preferred. They can be used in combination or may be used alone. The surface treatment may be performed by coprecipitation, alternatively, the surfaces of particles may be covered with alumina in the first place, and then the alumina-covered surface may be covered with silica, or vice versa, according to purposes. The surface-covered layer may be porous layer, if necessary, but a homogeneous and dense surface is generally preferred.

The specific examples of the nonmagnetic inorganic powders which can be used in the lower layer in the present invention and the producing methods are disclosed in WO 98/35345.

By the addition of carbon blacks to the lower layer, a desired micro Vickers' hardness can be obtained, surface electrical resistance (Rs) and light transmittance can be reduced as well, as are well-known effects. It is also possible to bring about the effect of stocking a lubricant by the addition of carbon blacks to the lower layer. Furnace blacks for rubbers, thermal blacks for rubbers, carbon blacks for coloring and acetylene blacks can be used as carbon blacks. The following characteristics should be optimized by the carbon blacks added to the lower layer according to desired effects, and sometimes more effects can be obtained by the combined use.

The carbon blacks which are used in the lower layer according to the present invention have a specific surface area (S_{BET}) of generally from 100 to 500 m²/g, preferably from 150 to 400 m²/g, a DBP oil absorption amount of generally from 20 to 400 ml/100 g, preferably from 30 to 400 ml/100 g, and an average particle size of generally from 5 to 80 nm, preferably from 10 to 50 nm, and more preferably from 10 to 40 nm. A small amount of carbon blacks having an average particle size of larger than 80 nm may be contained in the lower layer. Carbon blacks for use in the lower layer have pH of from 2 to 10, a water content of from 0.1 to 10%, and a tap density of from 0.1 to 1 g/ml.

The specific examples of the carbon blacks which can be used in the lower layer are disclosed in WO 98/35345. These carbon blacks can be used within the range not exceeding 50 mass % based on the above nonmagnetic inorganic powders (exclusive of carbon blacks) and not exceeding 40 mass % based on the total mass (i.e., the total weight) of the nonmagnetic layer. These carbon blacks can be used alone or in combination. With respect to carbon blacks which can be used in the present invention, the description, e.g., in Handbook of Carbon Blacks (edited by Carbon Black Association of Japan) can be referred to.

The binder resins, lubricants, dispersants, additives, solvents, dispersing methods, and others used for the magnetic layer can be used in the lower layer and the backing layer. In particular, with respect to the amounts and the kinds of binder resins, additives, the amounts and the kinds of dispersants, well-known prior art techniques regarding the magnetic layer can be applied to the lower layer.

The magnetic recording medium in the present invention can be produced by dispersing a ferromagnetic powder, a binder, a fatty acid, a carbon black, an abrasive, and if necessary, additives, e.g., a dispersant, a lubricant, a stabilizer and an antistatic agent, in ordinarily used organic solvents, e.g., methyl ethyl ketone or cyclohexanone, to prepare a magnetic coating solution, coating the magnetic coating solution on a nonmagnetic support, and drying the coated magnetic layer. The magnetic layer is generally provided by directly coating on a nonmagnetic support, but the magnetic layer may be provided with intervening an adhesive layer or an under coat layer. Ferromagnetic powders, additives, organic solvents, dispersing methods and coating methods are disclosed in detail in JP-A-52-108 (corresponding to U.S. Pat. No. 4,135,016), JP-A-52-804, JP-A-54-21805 and JP-A-54-46011. The magnetic recording medium in the present invention can also be produced according to the methods disclosed in the above patents.

The sizes of various powders such as a ferromagnetic powder and a carbon black (hereinafter referred to as “particle size”) can be obtained by a high resolution transmission electron microphotograph and an image analyzer. A particle size can be obtained by tracing the outline of the particle of a high resolution transmission electron microphotograph by an image analyzer. That is, (1) when the shape of a particle is acicular, spindle-like or pole-like (provided that the height is larger than the maximum length of the base), the particle size is represented by the length of the long axis constituting the particle, i.e., a long axis length, (2) when the shape of a particle is tabular or pole-like (provided that the thickness and the height are smaller than the longest diameter of the tabular surface or the base), the particle size is represented by the longest diameter of the tabular surface or the base, i.e., the tabular diameter, and (3) when the shape of a particle is spherical, polyhedral or amorphous and the long axis constituting the particle cannot be specified from the shape, the particle size is represented by equivalent-circle diameter.

The average particle size of the powder is the arithmetic mean of the particle and obtained by measuring about 500 particles in the above manner.

In the above measurement, the short axis length of the particle (the maximum axis perpendicular to the long axis) is measured, and the arithmetic mean of (long axis length/short axis length) of each particle is taken as the average acicular ratio of the particle. The short axis length means the length of the short axis constituting the particle in the case (1), the thickness or the height in the case (2), and (long axis length/short axis length) is taken as 1 for convenience' sake in the case (3), since there is no distinction between the long axis and the short axis.

When the shape of a particle is specific, e.g., in the case of the above definition (1) of particle size, the average particle size is called an average long axis length, the average particle size is called an average tabular diameter and the arithmetic mean of (tabular diameter/thickness or height) is called an average tabular ratio in the case of definition (2), and the average particle size is called an average particle size in the case of definition (3).

### EXAMPLE

The present invention will be described in detail below with reference to specific examples, but the present invention should not be construed as being limited thereto. In the examples, “part” means “mass part” unless otherwise indicated.

### Example I-1

<Preparation of Lower Nonmagnetic Layer-Forming Coating Solution and Magnetic Layer-Forming Coating Solution>

Components of lower nonmagnetic layer-forming coating solution

| | | |
|---|---|---|
| Nonmagnetic powder, | 90 | parts |
| Titanium dioxide TiO₂ (rutile type) | | |
| Content of TiO₂: 90% or more | | |
| Average primary particle size: 0.035 μm | | |
| Specific surface area S_{BET}: 40 m²/g | | |
| pH: 7.0 | | |
| DBP oil absorption amount: 27 to 38 ml/100 g | | |
| Mohs' hardness: 6.0 | | |
| Surface-covering compound: Al₂O₃ | | |
| Carbon black | 10 | parts |
| (manufactured by Mitsubishi Carbon Co., Ltd.) | | |
| Average primary particle size: 16 nm | | |
| DBP oil absorption amount: 80 ml/100 g | | |
| pH: 8.0 | | |
| Specific surface area S_{BET}: 250 m²/g | | |
| Volatile content: 1.5% | | |
| Vinyl chloride copolymer | 12 | parts |
| MR110 (manufactured by Nippon Zeon Co., Ltd.) | | |
| Polyester polyurethane resin | 5 | parts |
| (containing a polar group, an —SO₃Na group) | | |
| neopentyl glycol/caprolactone polyol/MDI: | | |
| 0.9/2.6/1 (mass ratio) | | |
| content of an —SO₃Na group: 1 × 10⁻⁴ mol/g | | |
| Polyisocyanate | 3 | parts |
| Coronate L (manufactured by Nippon | | |
| Polyurethane Industries Co., Ltd.) | | |
| Butyl stearate | 1 | part |
| Stearic acid | 2 | parts |
| Oleic acid | 1 | part |
| Methyl ethyl ketone | 150 | parts |
| Cyclohexanone | 50 | parts |

Components of upper magnetic layer-forming coating solution

| | | |
|---|---|---|
| Ferromagnetic metal powder | 100 | parts |
| Composition: Fe/Co =70/30 (atomic ratio) | | |
| Coercive force: 2,300 Oe (184 kA/m) | | |
| Specific surface area S_{BET}: 47 m²/g | | |
| Crystallite size: 177 angstroms | | |
| Saturation magnetization (σₛ): 145 m²/kg | | |
| Average long axis length: 0.08 μm | | |
| Acicular ratio: 7.5 | | |
| pH: 9.4 | | |
| Water-soluble Na: 5 ppm | | |
| Water-soluble Ca: 10 ppm | | |
| Water-soluble Fe: 10 ppm | | |
| Surface-covering compound of magnetic | 3 | parts |
| powder (phenylphosphinic acid) | | |
| Vinyl chloride copolymer | 10 | parts |
| MR110 (manufactured by Nippon Zeon Co., Ltd.) | | |
| Polyester polyurethane resin | 2.5 | parts |
| (containing a polar group, an —SO₃Na group) | | |
| neopentyl glycol/caprolactone polyol/MDI: | | |
| 0.9/2.6/1 (mass ratio) | | |
| content of an —SO₃Na group: 1 × 10⁻⁴ mol/g | | |
| Polyisocyanate | 2.5 | parts |
| Coronate L (manufactured by Nippon | | |
| Polyurethane Industries Co., Ltd.) | | |
| alpha-Alumina (average particle size: 0.3 μm) | 10 | parts |
| Dichromium trioxide | 1 | part |
| Carbon black (average particle size: 0.10 μm) | 3.0 | parts |
| Butyl stearate | 1 | part |
| Stearic acid | 2 | parts |
| Oleic acid | 1 | part |
| Methyl ethyl ketone | 150 | parts |
| Cyclohexanone | 50 | parts |

Each component of the above nonmagnetic layer-forming solution or magnetic layer-forming solution was kneaded by a continuous kneader and then dispersed in a sand mill. The above polyisocyanate was added to each of the above-obtained dispersion solutions, 2.5 parts to the nonmagnetic layer dispersion solution and 3 parts to the magnetic layer dispersion solution, and further, 40 parts of methyl ethyl ketone was added to each dispersion solution. Each dispersion solution was filtered through a filter having an average pore diameter of 1 μm to prepare a nonmagnetic layer-forming coating solution and a magnetic layer-forming coating solution.

<Preparation of Back Coat Layer-Forming Coating Solution>

Components of back coat layer-forming coating solution

| | | |
|---|---|---|
| Fine particle carbon black powder | 100 | parts |
| BP-800 (average particle size: 17 nm, | | |
| manufactured by Cabot Co., Ltd.) | | |
| Coarse carbon black powder | 10 | parts |
| Thermal Black (average particle size: 230 nm, | | |
| manufactured by Cancarb Co., Ltd.) | | |
| Calcium carbonate | 80 | parts |
| Hakuenka O (average particle size: 40 nm, | | |
| manufactured by Shiroishi Kogyo Co., Ltd.) | | |
| alpha-Alumina | 5 | parts |
| HIT55 (average particle size: 200 nm, | | |
| Mohs' hardness: 8.5, manufactured by | | |
| Sumitomo Chemical Co., Ltd.) | | |
| Nitrocellulose resin | 140 | parts |
| Polyurethane resin | 15 | parts |
| Polyisocyanate | 40 | parts |
| Coronate L (manufactured by Nippon | | |
| Polyurethane Industries Co., Ltd.) | | |
| Polyester resin | 5 | parts |
| Dispersant: | | |
| Copper oleate | 5 | parts |
| Copper phthalocyanine | 5 | parts |
| Barium sulfate | 5 | parts |
| Solvent | | |
| Methyl ethyl ketone | 2,200 | parts |
| Butyl acetate | 300 | parts |
| Toluene | 600 | parts |

Each component of the above back coat layer-forming solution was kneaded by a continuous kneader and then dispersed in a sand mill. The obtained dispersion solution was filtered through a filter having an average pore diameter of 1 μm to prepare a back coat layer-forming coating solution.

Preparation of Magnetic Tape

The above-prepared lower nonmagnetic layer-forming coating solution and upper magnetic layer-forming coating solution were simultaneously multilayer-coated on a long size aromatic polyamide support (trade name: Mictoron, having a thickness of 4.4 μm, manufactured by Toray Industries Inc.) in a dry coating thickness of the nonmagnetic layer of 1.70 u and that of the magnetic layer of 0.15 μm. In this case, the aromatic polyamide support may be one subjected to corona discharge treatment. Subsequently, the coated layers were subjected to orientation while both layers were still wet with a cobalt magnet having a magnetic flux density of 0.3 tesla and a solenoid having a magnetic flux density of 0.15 tesla, and then dried, thereby a nonmagnetic layer and a magnetic layer were formed.

The above-prepared coating solution for forming a back coat layer was coated on the other side (the side opposite to the magnetic layer) of the aromatic polyamide support after that in a dry thickness of 0.4 μm to prepare a back coat layer, thereby a magnetic recording laminate roll comprising a support having on one side a nonmagnetic layer and a magnetic layer and on the other side a back coat layer was obtained.

The thus-obtained magnetic recording laminate roll was run through a heat treatment zone at 120° C. at tension of 29.4 N/m (3.0 kg/m) for 5 seconds to perform heat treatment. After heat treatment, the magnetic recording laminate roll was further subjected to calendering treatment through a calender of 7 stages comprising metal rolls alone (at 90° C., 294 kN/m (linear pressure: 300 kg/cm)), and wound up at a tension of 5 kg.

The magnetic recording laminate roll was stored in a heat treatment zone at 70° C. for 24 hours during the period of time until it was slit.

After storage, the magnetic recording laminate roll was slit to a width of 3.8 mm, thereby a magnetic tape for computer data recording (hereinafter merely referred to as a magnetic tape) according to the present invention was obtained. The obtained magnetic tape was wound by 125 min length into a cartridge for DDS data. The surface roughness (Ra) (defined in JIS B 0601) of the back coat layer of the thus-obtained magnetic tape was 6.5 nm.

### Examples I-2 to I-4

Magnetic tapes were prepared in the same manner as in Example I-1 except for changing the addition amount of the carbon black in the magnetic layer to modify the number of protrusions on the magnetic layer surface. The addition amounts of the carbon black in Examples I-2 to I-4 are shown below.

Example I-2: 4.5 parts

Example I-3: 6.0 parts

Example I-4: 7.5 parts

### Comparative Example I-1

The magnetic tape shown in Table I-1 below was prepared in the same manner as in Example I-1 except that the carbon black was not added to the upper magnetic layer.

### Comparative Example I-2

The magnetic tape shown in Table I-1 below was prepared in the same manner as in Example I-1 except that 10 parts of the carbon black was added to the upper magnetic layer. The same aromatic polyamide support as in Example I-1 was used.

The characteristics of the magnetic tapes prepared in the examples and comparative examples were measured and evaluated according to the manner described below.

The results obtained are shown in Table I-1 below.

TABLE I-1

| | Number of | μValue | | | | | | Running |
|---|---|---|---|---|---|---|---|---|
| | Surface | between | Reproduc- | | Sendust | Head | Staining | Durability |
| | Protrusion | Layers | tion | DO | Abrasion | Wear | due to | (5,000 p is |
| Example | (number/20 nm | 1 p | Output | (number/ | Loss | Loss | Scratched | taken as the whole |
| No. | to 500 nm) | 10 p | (%) | min) | (μm) | (μm/hr) | Powder | course) |
| Example I-1 | 25 | 0.26 | 100 | 2 | 4.8 | 4 | ◯ | ran the |
| | | 2.27 | | | | | | whole |
| | | | | | | | | course |
| Example I-2 | 52 | 0.22 | 99 | 2 | 4.5 | 4 | ◯ | ran the |
| | | 0.23 | | | | | | whole |
| | | | | | | | | course |
| Example I-3 | 103 | 0.20 | 98 | 3 | 4.0 | 3 | ◯ | ran the |
| | | 0.21 | | | | | | whole |
| | | | | | | | | course |
| Example I-4 | 142 | 0.19 | 96 | 4 | 3.6 | 3 | ◯ | ran the |
| | | 0.21 | | | | | | whole |
| | | | | | | | | course |
| Comparative | 6 | 0.33 | 100 | 2 | 13.5 | 10 | ◯ | 853 p, |
| Example I-1 | | 0.38 | | | | | | stopped due |
| | | | | | | | | to sticking |
| Comparative | 173 | 0.18 | 92 | 12 | 3.2 | 1 | x | ran the |
| Example I-2 | | 0.18 | | | | | | whole |
| | | | | | | | | course |

Evaluation of Magnetic Tape

1) Measurement of the Number of Protrusions on the Magnetic Layer Surface

The number of protrusions on a magnetic layer surface can be measured with AFM (Atomic Force Microscope). In the present invention, NANOSCOPE III (manufactured by DIGITAL INSTRUMENT) was used in the measurement of protrusions.

The measurement is performed by scanning the area of 30 μm×30 μm of the measuring range on the magnetic tape by contact mode at scanning velocity of 0.25 second/line or more.

The protrusion height in the present invention means the distance from the following reference plane to the top of the protrusion. The reference plane is the plane where the volumes of the convexities and the concavities in the area of measurement of a magnetic layer become equal. In specific terms, by the measurement of the number of protrusions with AFM, the numbers intersecting the protrusions at respective heights can be obtained when a magnetic tape is sliced at respective heights from the reference plane, e.g., the number intersecting protrusions in the case where the magnetic tape is sliced at the height of 20 nm from the reference plane, the number intersecting protrusions in the case where the magnetic tape is sliced at the height of 25 nm from the reference plane, and the number intersecting protrusions in the case where the magnetic tape is sliced at the height of 30 nm from the reference plane. Accordingly, in the present invention, the total number intersecting protrusions in the case where a magnetic tape is sliced at the height from 20 nm to 50 nm from the reference plane is restricted to 20 to 150. In the present invention, the number obtained by subtracting the number intersecting the protrusions when a magnetic layer surface is sliced at the height of 50.5 nm from the reference plane from the number intersecting the protrusions when sliced at the height of 19.5 nm from the reference plane is taken as the number of protrusion.

2) Friction Coefficient Between Layers (μ Value)

For measuring the friction coefficient between layers, a magnetic tape is wound around the surface of a cylinder of 30 mmφ with the carbon layer of the back coat surface upside. A magnetic tape to be measured is put thereon so that the magnetic layer surface of the magnetic tape comes to be contact with the carbon layer and the friction coefficient between layers of the magnetic layer surface and the carbon layer surface being in contact is measured.

The magnetic layer surface of the magnetic tape is made into contact with the carbon layer surface and a load of 10 g (T₁) is applied on the tape, the tape of pulling length of 50 mm is pulled at a velocity of 10 mm/sec with applying a tension (T₂), and 10 passes (10 p) are continuously repeated. The friction coefficient between layers of the magnetic layer surface and the back coat layer surface is obtained from T₂/T₁.

3) Reproduction Output

Single frequency signal of 13.5 MHz is recorded at an optimal recording current with a DDS drive and the reproduction output is measured. The output value was shown in a relative value taking the reproduction output of Comparative Example I-i as 100.

4) Dropout (DO)

A signal of a frequency of 9 MHz is written at an optimal current value with a DDS drive, and the reproduction output is counted with a dropout counter (a product manufactured by Shibasoku K.K.). The measurement is performed for 5 minutes and the average number per a minute of DO of 15 Ξsec/−10 dB is found.

5) The Number of Times of Running (Running Durability Test and Generation of Scratched Powder)

A magnetic tape of the length of 1 minute is run with a DDS drive by 5,000 passes repeatedly. At the point when the reduction of 6 dB output is generated due to clogging of the magnetic head during running, the number of running is measured and evaluated.

At the same time, staining due to scratched powder of each part in the DDS drive, e.g., a guide roll part, a head cylinder part and a capstan pinch roller part, is observed. When scratched powder abounds, there are high possibilities of the increase of DO and the generation of clogging. In the column of “staining due to scratched powder” in Table II-1, o means no staining, and x means great staining.

6) Sendust Bar Abrasion Loss

Abrasion loss is measured by using a wear bar of square pole (4.5 mm square) composed of the material of Al (aluminum)/Fe (iron)/Si (silica) of 5.4%/85.0%/9.6% and under the following conditions:

Tape length: 50 m×one going and returning

Tape velocity: 300 mm/sec

Load: 20 g

Bar up angle: 12 degree

temperature and humidity: 23° C. 50% RH

The abrasion loss of the wear bar measured on the above conditions is measured with an optical microscope of 400 magnifications.

7) Head Wear Loss

The measurement of head wear loss by running in an actual apparatus is performed as follows.

Head wear loss (i.e., head abrasion loss) is measured using a DDS drive under the atmosphere of 21° C. 50% RH with virgin one running being 2.5 hours.

Before running, the shape consists of an inverted quadrangular pyramid is engraved on the sliding surface of the head. After engraving, measurement is performed at six points of ridgelines of the quadrangular pyramid including diagonal lines. Since the distance between diagonal lines is set up at 7 to the distance to the apex of the quadrangular pyramid of the engraved depth direction being 1 (1/7), with this value as the standard, the reduced amount in the depth direction is found as the loss per time.

The results of evaluations of the magnetic tapes according to the present invention are shown in Table I-1.

It was found that the contribution of the surface of a magnetic layer to a magnetic tape was great. In Examples I-1 to I-4 according to the present invention, the influences by the friction coefficient in the surface protrusion on the surface property of the magnetic layer, the reproduction output in electromagnetic characteristics, abrasion loss, generation of scratched powder and running durability were examined. As a result, as shown in Examples I-i to I-4, wherein the number of the surface protrusions was from 20 to 140 (the range of the protrusion height of from 20 to 50 nm), every sample was low in p value between layers, showed reproduction output of almost 100%, generated no scratched powder, and showed well-balanced results.

The sample in Comparative Example I-1 showed great abrasion loss, and stopped during running durability test due to sticking and was poor in stability.

The sample in Comparative Example I-2 was low in reproduction output, high in dropout, and the generation of scratched powder caused clogging. This is presumably because the tips of the protrusions are scraped off when too many surface protrusions are on the magnetic layer surface, which causes the above phenomena.

As is apparent from the results in Table I-1, the magnetic tapes in the present invention show good results such that low in friction coefficient, hardly accompanied by abrasion, and very convenient to use, and so optimal as a magnetic tape for high density magnetic recording and computer data recording.

Since the thickness of the magnetic recording medium according to the present invention is very thin as a whole, great recording capacity can be achieved. Further, although the thickness of the magnetic recording medium is very thin as a whole, a magnetic tape low in abrasion, having highly reliable running durability and convenient to use, together with excellent electromagnetic characteristics suitable for high density recording, has been realized. Further, since the upper magnetic layer is extremely thin, the constitution of the magnetic recording medium according to the present invention is very advantageous for high density recording.

Accordingly, the magnetic recording medium according to the present invention can be advantageously used as a magnetic tape for computer data recording.

Further, even when the magnetic recording medium according to the present invention is used as a magnetic tape for a magnetic recording and reproducing system capable of recording and reproducing on a narrow track pitch, a problem such as off-track is not caused, accordingly it is possible to perform highly reliable recording and reproduction of data.

### Example II-1

<Preparation of Lower Nonmagnetic Layer-Forming Coating Solution and Magnetic Layer-Forming Coating Solution>

Components of lower nonmagnetic layer-forming coating solution

| | | |
|---|---|---|
| Nonmagnetic powder, | 90 | parts |
| Titanium dioxide TiO₂ (rutile type) | | |
| Content of TiO₂: 90% or more | | |
| Average particle size: 0.035 μm | | |
| Specific surface area S_{BET}: 40 m²/g | | |
| pH: 7.0 | | |
| DBP oil absorption amount: 27 to 38 ml/l00 g | | |
| Mohs' hardness: 6.0 | | |
| Surface-covering compound: Al₂O₃ | | |
| Carbon black | 10 | parts |
| (manufactured by Mitsubishi Carbon Co., Ltd.) | | |
| Average particle size: 16 nm | | |
| DBP oil absorption amount: 80 ml/100 g | | |
| pH: 8.0 | | |
| Specific surface area S_{BET}: 250 m²/g | | |
| Volatile content: 1.5% | | |
| Vinyl chloride copolymer | 12 | parts |
| MR110 (manufactured by Nippon Zeon Co., Ltd.) | | |
| Polyester polyurethane resin | 5 | parts |
| (containing a polar group, an —SO₃Na group) | | |
| neopentyl glycol/caprolactone polyol/MDI: | | |
| 0.9/2.6/1 (mass ratio) | | |
| content of an —SO₃Na group: 1 × 10⁻⁴ mol/g | | |
| Polyisocyanate | 3 | parts |
| Coronate L (manufactured by Nippon | | |
| Polyurethane Industries Co., Ltd.) | | |
| Butyl stearate | 1 | part |
| Stearic acid | 2 | parts |
| Oleic acid | 1 | part |
| Methyl ethyl ketone | 150 | parts |
| Cyclohexanone | 50 | parts |

Components of upper magnetic layer-forming coating solution

| | | |
|---|---|---|
| Ferromagnetic metal powder | 100 | parts |
| Composition: Fe/Co = 70/30 (atomic ratio) | | |
| Coercive force: 2,300 Oe (184 kA/m) | | |
| Specific surface area S_{BET}: 47 m²/g | | |
| Crystallite size: 177 angstroms | | |
| Saturation magnetization (σs): 145 m²/kg (emu/g) | | |
| Average long axis length: 0.08 μm | | |
| Acicular ratio: 7.5 | | |
| pH: 9.4 | | |
| Water-soluble Na: 5 ppm | | |
| Water-soluble Ca: 10 ppm | | |
| Water-soluble Fe: 10 ppm | | |
| Surface-covering compound of magnetic | 3 | parts |
| powder (phenylphosphinic acid) | | |
| Vinyl chloride copolymer | 10 | parts |
| MR110 (manufactured by Nippon Zeon Co., Ltd.) | | |
| Polyester polyurethane resin | 2.5 | parts |
| (containing a polar group, an —SO₃Na group) | | |
| neopentyl glycol/caprolactone polyol/MDI: | | |
| 0.9/2.6/1 (mass ratio) | | |
| content of an —SO₃Na group: 1 × 10⁻⁴ mol/g | | |
| Polyisocyanate | 2.5 | parts |
| Coronate L (manufactured by Nippon | | |
| Polyurethane Industries Co., Ltd.) | | |
| alpha-Alumina (average particle size: 0.3 μm) | 10 | parts |
| Dichromium trioxide | 1 | part |
| Carbon black (average particle size: 0.10 μm) | 1.50 | parts |
| Butyl stearate | 1 | part |
| Stearic acid | 2 | parts |
| Oleic acid | 1 | part |
| Methyl ethyl ketone | 150 | parts |
| Cyclohexanone | 50 | parts |

Each component of the above nonmagnetic layer-forming solution or magnetic layer-forming solution was kneaded by a continuous kneader and then dispersed in a sand mill. The above polyisocyanate was added to each of the above-obtained dispersion solutions, 2.5 parts to the nonmagnetic layer dispersion solution and 3 parts to the magnetic layer dispersion solution, and further, 40 parts of methyl ethyl ketone was added to each dispersion solution. Each dispersion solution was filtered through a filter having an average pore diameter of 1 μm to prepare a nonmagnetic layer-forming coating solution and a magnetic layer-forming coating solution.

<Preparation of Back Coat Layer-Forming Coating Solution>

Components of back coat layer-formincg coating solution

| | | |
|---|---|---|
| Fine particle carbon black powder | 100 | parts |
| BP-800 (average particle size: 17 nm, | | |
| manufactured by Cabot Co., Ltd.) | | |
| Coarse carbon black powder | 10 | parts |
| Thermal Black (average particle size: 230 nm, | | |
| manufactured by Cancarb Co., Ltd.) | | |
| Calcium carbonate | 80 | parts |
| Hakuenka O (average particle size: 40 nm, | | |
| manufactured by Shiroishi Kogyo Co., Ltd.) | | |
| alpha-Alumina | 5 | parts |
| HIT55 (average particle size: 200 nm, | | |
| Mohs'hardness: 8.5, manufactured by | | |
| Sumitomo Chemical Co., Ltd.) | | |
| Nitrocellulose resin | 140 | parts |
| Polyurethane resin | 15 | parts |
| Polyisocyanate | 40 | parts |
| Coronate L (manufactured by Nippon | | |
| Polyurethane Industries Co., Ltd.) | | |
| Polyester resin | 5 | parts |
| Dispersant: | | |
| Copper oleate | 5 | parts |
| Copper phthalocyanine | 5 | parts |
| Barium sulfate | 5 | parts |
| Solvent | | |
| Methyl ethyl ketone | 2,200 | parts |
| Butyl acetate | 300 | parts |
| Toluene | 600 | parts |

Each component of the above back coat layer-forming solution was kneaded by a continuous kneader and then dispersed in a sand mill. The obtained dispersion solution was filtered through a filter having an average pore diameter of 1 μm to prepare a back coat layer-forming coating solution.

Preparation of Magnetic Tape

The above-prepared lower nonmagnetic layer-forming coating solution and upper magnetic layer-forming coating solution were simultaneously multilayer-coated on a long size aromatic polyamide support (trade name: Mictoron, having a thickness of 4.4 μm, manufactured by Toray Industries Inc.) in a dry coating thickness of the nonmagnetic layer of 1.70 μm and that of the magnetic layer of 0.15 μm. In this case, the aromatic polyamide support may be one subjected to corona discharge treatment. Subsequently, the coated layers were subjected to orientation while both layers were still wet with a cobalt magnet having a magnetic flux density of 0.3 tesla and a solenoid having a magnetic flux density of 0.15 tesla, and then dried, thereby a nonmagnetic layer and a magnetic layer were formed.

The above-prepared coating solution for forming a back coat layer was coated on the other side (the side opposite to the magnetic layer) of the aromatic polyamide support after that in a dry thickness of 0.4 μm to prepare a back coat layer, thereby a magnetic recording laminate roll comprising a support having on one side a nonmagnetic layer and a magnetic layer and on the other side a back coat layer was obtained.

The thus-obtained magnetic recording laminate roll was run through a heat treatment zone at 120° C. at tension of 29.4 N/m (3.0 kg/m) for 5 seconds to perform heat treatment. After heat treatment, the magnetic recording laminate roll was further subjected to calendering treatment through a calender of 7 stages comprising metal rolls alone (at 90° C., 294 kN/m (linear pressure: 300 kg/cm)), and wound up at a tension of 5 kg.

The magnetic recording laminate roll was stored in a heat treatment zone at 70° C. for 24 hours during the period of time until it was slit.

After storage, the magnetic recording laminate roll was slit to a width of 3.8 mm, thereby a magnetic tape for computer data recording (hereinafter merely referred to as a magnetic tape) according to the present invention was obtained. The obtained magnetic tape was wound by 125 min length into a cartridge for DDS data. The surface roughness (Ra) of the back coat layer of the thus-obtained magnetic tape was 6.5 nm.

### Examples II-2 and II-3 and Comparative Examples II-1 and II-2

Magnetic tapes were prepared in the same manner as in Example II-1 except for changing the addition amount of the carbon black in the magnetic layer as shown below to modify the protrusion distribution of protrusion height on the magnetic layer surface.

Example II-2: 3.00 parts

Example II-3: 0.75 parts

Comparative Example II-1: 0 part

Comparative Example II-2: 5.00 parts

The results obtained are shown in Table II-1 below.

TABLE II-1

| | | | | | | | Total | |
|---|---|---|---|---|---|---|---|---|
| | | | | | | | Number of | Error |
| | Number of Protrusions | | | Distribution of Protrusions (%) | | | Protrusions | Rate |
| Example No. | a | B | c | A | B | C | (a + b + c) | (10⁻⁴) |
| Example II-1 | 13 | 4 | 1 | 72.2 | 22.2 | 5.6 | 18 | 3.4 |
| Example II-2 | 17 | 8 | 5 | 56.7 | 26.7 | 16.6 | 30 | 3.1 |
| Example II-3 | 13 | 2 | 0 | 86.7 | 13.3 | 0.0 | 15 | 3.7 |
| Comparative | 8 | 0 | 0 | 100.0 | 0.0 | 0.0 | 8 | 3.2 |
| Example II-1 | | | | | | | | |
| Comparative | 36 | 71 | 71 | 20.2 | 39.9 | 39.9 | 178 | 1.2 |
| Example II-2 | | | | | | | | |

| | μValue | | | | Sendust | Head | Staining | |
|---|---|---|---|---|---|---|---|---|
| | between | | | | Abrasion | Wear | due to | Running |
| | Layers | | Reproduction | DO | Loss | Loss | Scratched | Durability |
| Example No. | 1 p | 10 p | Output (%) | (number/min) | (μm) | (μm/hr) | Powder | (5,000 p) |
| Example II-1 | 0.295 | 0.315 | 100 | 2 | 6.2 | 6.8 | ◯ | ran the |
| | | | | | | | | whole |
| | | | | | | | | course |
| Example II-2 | 0.258 | 0.272 | 100 | 1 | 4.2 | 4.3 | ◯ | ran the |
| | | | | | | | | whole |
| | | | | | | | | course |
| Example II-3 | 0.320 | 0.345 | 101 | 2 | 7.8 | 8.8 | ◯ | ran the |
| | | | | | | | | whole |
| | | | | | | | | course |
| Comparative | 0.340 | 0.400 | 100 | 4 | 13.8 | 11 | ◯ | 638 p, |
| Example II-1 | | | | | | | | stopped |
| | | | | | | | | due to |
| | | | | | | | | sticking |
| Comparative | 0.222 | 0.225 | 93 | 16 | 2.7 | 1.2 | x | 4,635 p |
| Example II-2 | | | | | | | | due to |
| | | | | | | | | increase |
| | | | | | | | | of DO |

Evaluation of Magnetic Tape

1) Measurement of the Protrusion Distribution of the Protrusion Height on the Magnetic Layer Surface

The measurement was performed using AFM (Atomic Force Microscope) NANOSCOPE III (manufactured by DIGITAL INSTRUMENT) in the manner described above.

2) Friction Coefficient Between Layers (μ Value)

For measuring the friction coefficient between layers, a magnetic tape is wound around the surface of a cylinder of 30 mm with the carbon layer of the back coat surface upside. A magnetic tape to be measured is put thereon so that the magnetic layer surface of the magnetic tape comes to be contact with the carbon layer and the friction coefficient between layers of the magnetic layer surface and the carbon layer surface being in contact is measured.

The magnetic layer surface of the magnetic tape is made into contact with the carbon layer surface and a load of 10 g (T₁) is applied on the tape, the tape of pulling length of 50 mm is pulled at a velocity of 10 mm/sec with applying a tension (T₂), and 10 passes (10 p) are continuously repeated. The friction coefficient between layers of the magnetic layer surface and the back coat layer surface is obtained from T₂/T₁.

3) Reproduction Output

Single frequency signal of 13.5 MHz is recorded at an optimal recording current with a DDS drive and the reproduction output is measured. The output value was shown in a relative value taking the reproduction output of Comparative Example II-1 as 100.

4) Error Rate

The measurement of error rate of the magnetic tape sample was performed in a usual manner with an evaluator ML4500B (manufactured by Media Logic Co.) and a DDS drive (manufactured by Hewlett Packard Co.).

5) Dropout (DO)

A signal of a frequency of 9 MHz is written at an optimal current value with a DDS drive, and the reproduction output is counted with a dropout counter (a product manufactured by Shibasoku K.K.). The measurement is performed for 5 minutes and the average number per a minute of DO of 15 μsec/−10 dB is found.

6) Running Durability (Running Property, Generation of Scratched Powder and Staining)

A magnetic tape of the length of 1 minute is run with a DDS drive by 5,000 passes repeatedly. At the point when the reduction of 6 dB output is generated due to clogging of the magnetic head during running, the number of running is measured and running property was evaluated.

At the same time, staining due to scratched powder of each part in the DDS drive, e.g., a guide roll part, a head cylinder part and a capstan pinch roller part, is observed. When scratched powder abounds, there are high possibilities of the increase of DO and the generation of clogging. In the column of “staining due to scratched powder” in Table II-1, o means no staining, and x means great staining.

7) Sendust Bar Abrasion Loss

Abrasion loss is measured by using a wear bar of square pole (4.5 mm square) composed of the material of Al (aluminum)/Fe (iron)/Si (silica) of 5.4%/85.0%/9.6% (atomic ratio) and under the following conditions:

Tape length: 50 m×one going and returning

Tape velocity: 300 mm/sec

Load: 20 g

Bar up angle: 12 degree

temperature and humidity: 23° C. 50% RH

The abrasion loss of the wear bar measured on the above conditions is measured with an optical microscope of 400 magnifications.

8) Head Wear Loss

The measurement of head wear loss by running in an actual apparatus is performed as follows.

Head wear loss is measured using a DDS drive under the atmosphere of 21° C. 50% RH with virgin one running being 2.5 hours.

Before running, the shape consists of an inverted quadrangular pyramid is engraved on the sliding surface of the head. After engraving, measurement is performed at six points of ridgelines of the quadrangular pyramid including diagonal lines. Since the distance between diagonal lines is set up at 7 to the distance to the apex of the quadrangular pyramid of the engraved depth direction being 1 (1/7), with this value as the standard, the reduced amount in the depth direction is found as the loss per time.

The results of evaluations of the magnetic tapes according to the present invention are shown in Table II-1.

It was found that the contribution of the protrusion distribution of the protrusion height on the surface of a magnetic layer to a magnetic tape was great. Examples II-1 to II-3 in the present invention show the protrusion distribution of the protrusion height according to the present invention. The influences by error rate evaluation which shows the reliability of data, the friction coefficient, the reproduction output in electromagnetic characteristics, abrasion loss, generation of scratched powder and running durability were examined. As a result, as shown in Examples II-1 to II-3, wherein occupancies (A), (B) and (C) of the protrusion number a, b and c in region A, region B and region C were all in the range of the present invention, every magnetic tape was low in error rate, low in head wear, generated no scratched powder (staining), excellent in running durability, and best-balanced.

In Comparative Example II-2, wherein (B) and (C) were higher as compared with the present invention, error rate was high, DO due to scratched powder and clogging were generated, and reliability was inferior. This is presumably because the tips of the protrusions are scraped off when too many surface protrusions are on the magnetic layer surface, which causes the above phenomena.

In Comparative Example II-1, wherein (B) and (C) were lower as compared with the present invention, error rate was high, head wear loss was great, and tape running stopped at 638 p due to sticking. Further, the surface of the magnetic layer was scraped off and many scratches were generated and the durability of the magnetic layer was inferior.

As is apparent from the results in Table II-1, the magnetic tapes in the present invention show good results such that error rate is low and highly reliable as a result of specifying the protrusion distribution of the protrusion heights, the friction coefficient is low, hardly accompanied by abrasion, and very convenient to use, and so optimal as a magnetic tape for high density magnetic recording and computer data recording.

Since the thickness of the magnetic recording medium according to the present invention is very thin as a whole, great recording capacity can be achieved. Further, although the thickness of the magnetic recording medium is very thin as a whole, a magnetic tape low in abrasion, having high running durability and convenient to use, together with excellent electromagnetic characteristics low in error rate and highly reliable well-suited for high density recording has been realized. Further, the present invention can provide a magnetic recording medium of the constitution having an extremely thin upper magnetic layer inexpensively.

Accordingly, the magnetic recording medium according to the present invention can be advantageously used as a magnetic tape for computer data recording.

Further, even when the magnetic recording medium according to the present invention is used as a magnetic tape for a magnetic recording and reproducing system capable of recording and reproducing on a narrow track pitch, a problem such as off-track is not caused, accordingly it is possible to perform highly reliable recording and reproduction of data.

While the invention has been described in detail and with reference to specific examples thereof, it will be apparent to one skilled in the art that various changes and modifications can be made therein without departing from the spirit and scope thereof.

What is claimed is:

1. A magnetic recording medium comprising a support having provided on one side thereof a magnetic layer containing a ferromagnetic powder and a binder, wherein the magnetic layer surface has protrusions having a height of from 20 to 50 nm in the number of from 20 to 150 per 900 μm² of the surface.

2. The magnetic recording medium as claimed in claim 1, wherein the support is an aromatic polyamide support or a polyethylene naphthalate support having a thickness of from 1.0 to 6.0 μm.

3. The magnetic recording medium as claimed in claim 1, wherein the entire thickness of the magnetic recording medium is 7.0 μm or less.

4. The magnetic recording medium as claimed in claim 1, wherein the magnetic layer of the magnetic recording medium has a thickness of from 0.01 to 0.25 μm.

5. The magnetic recording medium as claimed in claim 1, wherein the magnetic recording medium is a magnetic tape for a magnetic recording and reproducing system having a track breadth (track pitch) of 7.0 μm or less.

6. The magnetic recording medium as claimed in claim 1, wherein the magnetic recording medium is a magnetic tape for computer data recording.

7. The magnetic recording medium as claimed in claim 1, wherein the magnetic recording medium is used for recording and reproduction by a helical scan system.

8. A magnetic recording medium comprising a support having provided thereon a magnetic layer containing a ferromagnetic powder and a binder, wherein the magnetic layer surface has the following protrusion distributions of the protrusion heights:
protrusion number a of protrusion height of region A (20 nm or more and less than 30 nm) accounts for from 52.5 to 92.5% (A),
protrusion number b of protrusion height of region B (30 nm or more and less than 40 nm) accounts for from 9 to 29% (B), and
protrusion number c of protrusion height of region C (40 nm or more) accounts for from 0 to 18.5% (C),
where 100×a/(a+b+c)=A, 100×b/(a+b+c)=B, and 100×c/(a+b+c)=C.

9. The magnetic recording medium as claimed in claim 8, wherein a lower layer (a nonmagnetic layer) containing a nonmagnetic powder and a binder as the main components is provided between the support and the magnetic layer.

10. The magnetic recording medium as claimed in claim 8, wherein the support is an aromatic polyamide support or a polyethylene naphthalate support having a thickness of from 1.0 to 6.0 μm.

11. The magnetic recording medium as claimed in claim 8, wherein the entire thickness of the magnetic recording medium is 7.0 μm or less.

12. The magnetic recording medium as claimed in claim 8, wherein the magnetic layer has a thickness of from 0.01 to 0.25 μm.

13. The magnetic recording medium as claimed in claim 8, wherein the magnetic recording medium is a magnetic tape for a magnetic recording and reproducing system having a track breadth (track pitch) of 7.0 μm or less.

14. The magnetic recording medium as claimed in claim 8, wherein the magnetic recording medium is a magnetic tape for computer data recording.

15. The magnetic recording medium as claimed in claim 8, wherein the magnetic recording medium is used for recording and reproduction by a helical scan system.
